(19) United States
(12) Patent Application Publication
(10) Pub. No.: US 2001/0038385 A1
(43) Pub. Date: Nov. 8, 2001

(54) Display driver with double calibration means

(75) Inventors: Andy Catalin Negoi, Adliswil (CH); Adam Jonathon Smith, Zurich (CH)

Correspondence Address: Corporate Patent Counsel, U.S. Philips Corporation, 580 White Plains Road, Tarrytown, NY, 10591, US

(73) Assignee: KONINKLIJKE PHILIPS ELECTRONICS N.V.

(21) Appl. No.: 09/834,826

(22) Filed: Apr. 13, 2001

(30) Foreign Application Priority Data
Apr. 14, 2000 (EP) 00201342.3

(51) Int. Cl. G09G 5/00

(52) U.S. Cl. 345/204

(57) ABSTRACT

A display driver device with double calibration allows the manufacturer of the display driver device to correct the manufacturing process related spread of parameters by storing basic settings, while the manufacturer of display modules can store correction factors to tailor the characteristics of a display module containing a particular display driver device and a particular display device.

The present invention relates to a driver circuit for a display device including a means for storing a basic setting of an adjustable characteristic of the driver circuit.

The present invention also relates to a method of adjusting an individual property of a display module containing a display device and a driver circuit connected to this display device.

Such a driver circuit for a display device is known from the data sheet of the integrated circuit PCF 2103 in the 1998 Philips Data Handbook IC03a ‘semiconductors for wired telecom systems’. In order to properly drive an LCD display, the driver circuit must provide multiple waveforms at a certain multiplex rate, where the waveforms also have specific bias levels. The known driver circuit includes an LCD bias voltage generator, which can be programmed to adapt the LCD bias voltage to the display device chosen to obtain optimal optical performance from the LCD Display. Most LCD display devices require the off voltage of the drive signal to remain below a certain lower threshold, while the on-voltage must exceed a certain higher threshold in order to yield an acceptable contrast. Since both the lower and higher thresholds depend on temperature, viewing angle and display device, the user is provided with a contrast control to adjust the characteristics of the driver circuit, so that they match the characteristics of the display device. Characteristics of the LCD display that can be adjusted to yield optimal optical quality are contrast and transparency.

The contrast control is necessary because of spreads in the manufacturing process of both the driver circuit and the display device. Also different models of display devices exhibit different characteristics.

A disadvantage of the known driver circuit for a display device is that, as a result of the manufacturing spread, the setting of the driver circuit is not optimized for the display device to which it is to be connected and that, therefore, a contrast control must be provided for the user to enable him to obtain a display with optimum optical quality.

It is an object of the present invention to provide a driver device that is optimized for obtaining a display with optimum optical quality without the need for adjustment by the user.

To achieve this, the driver circuit is characterized in that the driver circuit includes a means for storing a correction factor to correct the basic setting of the adjustable characteristic of the driver circuit and in that the driver circuit is operative to adjust the adjustable characteristic based on the basic setting and the correction factor.

Driver devices manufactured in a diffusion process can have tolerances as large as 20%. The basic setting allows the manufacturer of the driver device to correct for the IC manufacturing spread of the driver circuit. The manufacturer of the driver device can store a basic setting in the device which represents a compromise setting on the basis of which the driver device can generate a drive signal that allows many display devices to operate within the optical range of the display device.

When a specific driver device is combined with a specific display device to a display module, the basic settings of the driver device can be sub-optimum for that specific display device. This maybe caused by the manufacturing spread of the display device or the differences between various product lines. The correction factor can be used by the manufacturer of the display module to apply a general correction factor which is based on a particular model of display devices, or the manufacturer of the display module can measure the optical quality of the display module and, by employing a calibration procedure, can determine a correction factor to adjust the basic setting that was stored by the driver device manufacturer. The driver device includes means for storing this correction factor. Because the driver device uses both the stored basic setting and the stored correction factor to adjust its adjustable characteristics, the manufacturer of the display module can optimize the optical quality of the associated display module. Since the display quality can be optimized by the manufacturer of the display module, the user receives a display module that needs no further optimization. As a consequence, the user no longer needs adjustment means in order to obtain a display with optimal optical quality.

The optical quality of the display device depends on several characteristics of the drive signal from the driver device. Important characteristics are the amplitude of the drive signal, frequency of the drive signal and temperature dependence.

The driver device can contain multiple means for storing a basic setting and multiple means for storing a correction factor. The basic setting and the correction factor can be stored in a memory. Each pair of basic setting and corresponding correction factor is then used by the driver circuit to adjust the characteristic to which the settings correspond.

The present invention will now be explained with reference to the drawing figures.

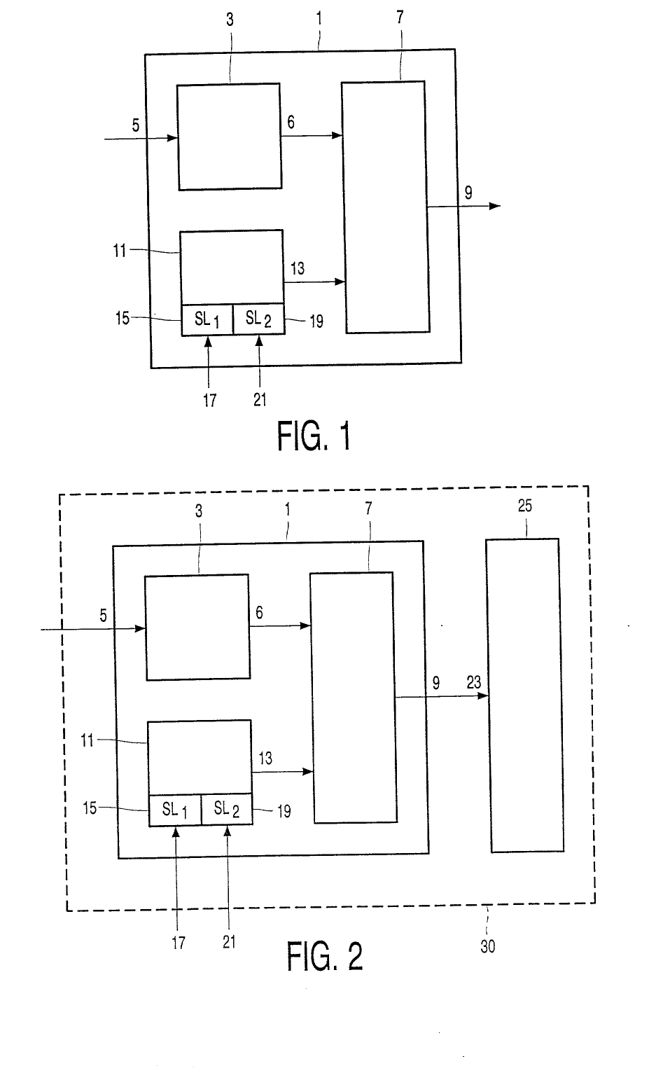

FIG. 1 shows the driver device according to the invention.

FIG. 2 shows the display module according to the invention.

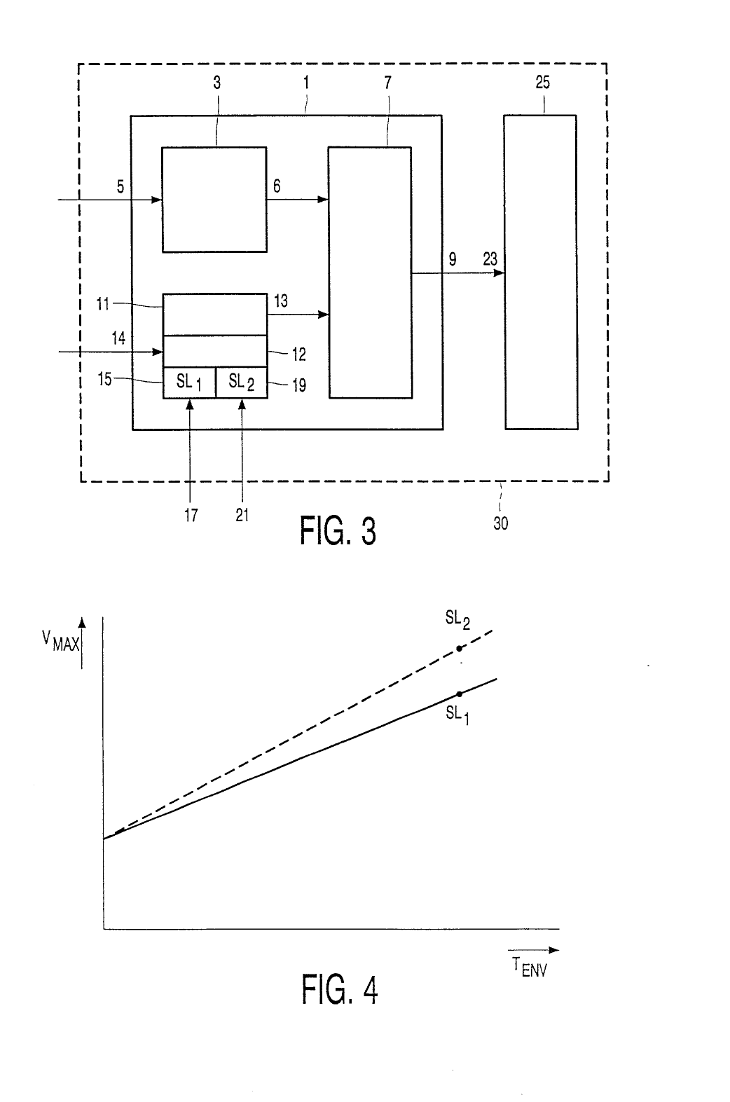

FIG. 3 shows a display module according to the invention which includes temperature compensation means.

The explanation is based on an LCD display device, but the invention can also be applied to other display technologies.

The driver device 1 according to FIG. 2 can be used to generate the drive signals for a display device. The driver device 1 includes a data processing unit 3 which receives data to be displayed via a data port 5. The data to be displayed, received via the data port 5, is then converted to data which is in a graphical format by the data processing unit 3. This data, which is in a graphical format, is then made available on an output 6 of the data processing unit 3 and is used by a waveform generation unit 7 to generate a drive signal for a display device.

This drive signal for the display device is made available on an output 9 of the waveform generation unit 7. For generating the drive signal for the display device, the waveform generation unit 7 receives information about characteristics of the drive signal for the display device from a waveform parameter unit 11 via an output 13. The waveform parameter unit includes a memory 15 for storing a basic setting and a memory 19 for storing a correction factor. The information about characteristics of the drive signal for the display device is generated by the waveform parameter unit 11 based on the basic setting stored in the memory 15 and the correction factor stored in the memory 19. The memory 15 can be accessed via a first port 17 and the memory 19 can be accessed via a second port 21. Using an addressing scheme it is also possible to access both memories 15, 19 via a common port, or to access both memories 15, 19 via the data port 5, which is also used for transfering the data to be displayed to the driver device 1.

By storing a basic setting determined by calibrating the driver device 1 in the memory 15, a characteristic of the driver device 1 can be altered resulting in an altered drive signal on the output 9 of the waveform generation unit 7.

The drive signal for the display device on the output 9 can be adjusted to suit a typical display device. The manufacturer of the driver device 1 guarantee specifications related to the basic setting can in this way when the driver device 1 is delivered to the customer.

By storing a correction factor in the memory 19, characteristics of the driver device 1 can be changed, away from the basic settings, resulting in a changed drive signal on the output 9 of the waveform generation unit 7.

By being able to change the characteristics away from the basic setting, the characteristics of the driver device 1 can be adjusted to a particular model display devices or to a specific display device connected to the driver device 1.

The display module 30 according to FIG. 2 includes both the driver device 1 and a display device 25. Now that a specific driver device is connected to a specific display device, it is possible to match the characteristics of the driver device 1 to the display device 25. The basic setting stored in the means 15 will yield an acceptable but sub-optimal optical quality of the display module. A manufacturer of the display module 30 can determine a correction factor and store the correction factor in the means 19 which can be accessed via the second port 21. In this way it is possible to adjust the characteristics of the driver device 1, which result in a drive signal on the output 9 of the waveform generation unit 7 which yields an optimal optical quality of the display module 30. The output 9 of the waveform generation unit 7 is connected to the input 23 of the display device 25. The driver device 1 and the display device 25 will remain combined through the life of the display module 30 in which they are included, resulting in a display module 30 which will yield optimal optical quality and requires no further adjustment means for a user.

The display unit 30 according to FIG. 3 includes the driver circuit 1 with a temperature correction means 12 and the display device 25. The temperature correction means 12 can be part of the waveform parameter unit 11. The temperature correction means 12 receives temperature information of the environment in which the display module 30 is operated. The temperature correction means 12 also receives parameters via the memory 15 and the memory 19. The waveform parameter unit 11 can supply a waveform parameter, via output 13, to the waveform generation unit, where the waveform parameter is determined based on the basic setting, the correction factor, and the temperature information.

FIG. 4 illustrates the use of the basic setting, the correction factor and the temperature information in order to obtain a waveform parameter.

The graph shows a possible relation between the basic setting, the correction factor, the temperature information and the maximum level of the drive signal.

The horizontal axis denotes the temperature information Tₑₙᵥ and the vertical axis denotes a waveform parameter, the maximum level of the drive signal Vₘₐₓ. The manufacturer of the driver circuit 1 determines a basic setting for the driver circuit 1 which takes into account the spread in the manufacturing process of the driver circuit 1 and a typical temperature dependence of a typical display device. This results in a relationship between the temperature information Tₑₙᵥ received by the driver circuit 1 and the maximum level Vₘₐₓ as shown by the curve in FIG. 4 which runs through a point SL1. This relationship can be optimized to suit a specific display device 25 to which the driver circuit 1 is connected by storing a correction factor SL2 in the means 19 for storing a correction factor. This results in a relationship between the temperature information Tₑₙᵥ received by the driver circuit 1 and the maximum level Vₘₐₓ, as shown by the curve in FIG. 4 which runs through a point SL2. Since the display module 30 has an optimized temperature correction, the display module 30 will yield optimum optical quality over a large temperature range. The user no longer needs further adjustment means to adjust for temperature changes. The correction factor can be determined either based on a specific driver circuit 1 and a specific display device 25 in a specific display module 30, or based on typical characteristics of display devices in a certain product line, or display devices manufactured with a specific manufacturing process, if the manufacturing process has small tolerances.

Also multiple basic settings and correction factors can be employed to provide more freedom to the manufacturer of display modules to optimize the optical quality..

In standard IC technology it is very difficult to obtain good accuracy for several parameters such as oscillator frequency, voltage levels and temperature dependence.

Therefore, the bias voltage generated by the driver device 1 exhibits a large spread. The driver device 1 also contains an oscillator in the waveform generation unit 7, and the frequency of the oscillator is subject to manufacturing process spread, supply and temperature variations. The spread can be as large as a factor of 1 to 3 (−50% to +150% of the nominal frequency). The frame frequency inaccuracy will cause the flickering of the display under fluorescent light, if the frame frequency is equal to the mains frequency, or a multiple of it. Tight tolerances are therefore required to prevent the frame frequency to be a multiple of 50 or 60 Hz.

The present invention allows the manufacturer of the driver device and the manufacturer of the display module to reduce tolerances of the bias voltage and oscillator frequency in the same way as outlined for the temperature dependence.

1. A driver circuit (1) for a display device including a means (15) for storing a basic setting of an adjustable characteristic of the driver circuit (1),
characterized in that the driver circuit (1) includes a means (19) for storing a correction factor to correct the basic setting of the adjustable characteristic of the driver circuit (1) and in that the driver circuit (1) is operative to adjust the adjustable characteristic based on the base setting and the correction factor.

2. A driver circuit as claimed in claim 1,
characterized in that the means (19) for storing a correction factor to correct the basic setting of the adjustable driver characteristic is accessible.

3. A driver circuit as claimed in claim 1, or 2,
characterized in that the means (15) for storing the basic setting of an adjustable driver characteristic is of the PROM type.

4. A driver circuit as claimed in claim 1, 2, 3, or 4,
characterized in that the correction factor which enables the driver circuit (1) to correct the basic setting of the adjustable characteristic of the driver circuit (1) has a substantially smaller adjustment range than the basic setting of the adjustable characteristic of the driver circuit (1).

5. A display module including the display driver (1) as claimed in claim 1 or 2, and a display device (25) connected to the display driver (1),
characterized in that the correction factor in the means (19) for storing a correction factor is based on an individual property of the display device (25).

6. A method of adjusting an individual property of a display module (30) containing a display device (25) and a driver circuit (1) connected to this display device (25),
characterized in that the method includes the following steps
determining a basic setting based on expected characteristics of the display device (25) and characteristics of the driver circuit (1),
storing the determined basic setting to be used by the driver circuit (1),
determining a correction factor to the basic setting based on the actual characteristic of the display device (25) and the characteristics of the driver circuit (1) when the basic setting is used, storing the correction factor to be used by the driver circuit (1).
